(19) United States
(12) Patent Application Publication
(10) Pub. No.: US 2006/0159394 A1
(43) Pub. Date: Jul. 20, 2006

(54) METHOD OF AND APPARATUS FOR MANUFACTURING FIBER GRATING DEVICES

(76) Inventor: Victor Grubsky, Chatsworth, CA (US)

Correspondence Address: VICTOR GRUBSKY, 11522 NORTH POEMA PLACE, APT. # 204, CHATSWORTH, CA, 91311, US

(21) Appl. No.: 10/905,758

(22) Filed: Jan. 19, 2005

(51) Int. Cl. G02B 6/34

(52) U.S. Cl. 385/37

(57) ABSTRACT

A long-period grating with axially-symmetric refractive index modulation and a clean transmission spectrum is formed by exposing an optical fiber to multiple writing beams of infrared light. The writing beams have substantially the same power and converge on the fiber in an axially-symmetric fashion, thus inducing axially-symmetric heating of the fiber. In one configuration, the writing beams are produced by a single reflective element placed next to the fiber. Multiple identical gratings on a number of fibers can be made in parallel using this arrangement by placing the fibers side by side, provided the light is properly focused so that all fibers are uniformly irradiated by the writing beams.

### BACKGROUND OF THE INVENTION

1. Field of the Invention

This invention relates to optical fiber grating devices, in particular to a method of and apparatus for producing high-quality long-period grating devices with an infrared laser.

2. Description of Related Art

Long-period fiber gratings are used for wavelength-selective filtering of light transmitted through the fiber. They are made by creating periodic perturbations in the fiber, typically with a period 50-1000 microns.

The properties of long-period gratings are directly related to the nature of the perturbations induced in the fiber. Long-period gratings can couple light from the core mode of the fiber into multiple cladding modes, depending on the periodicity and the transverse symmetry of the perturbations. If the perturbation is completely axially-symmetric, the core mode will be coupled only to axially-symmetric cladding modes. This is typically desirable in most of the grating applications because the spectrum of the grating will exhibit a few discreet, non-overlapping loss peaks with low polarization dependence (“clean” spectrum). In contrast, when the perturbations are axially asymmetric, the coupling between the core mode and a large number of asymmetric cladding modes is possible. This can result in unpredictable spectral response with overlapping multiple loss peaks and high polarization dependence.

A few methods exist for making perturbations in a fiber. Traditionally, long-period gratings are produced by exposing a fiber to ultraviolet (UV) light with a pre-determined spatial periodicity. This can be achieved either by scanning a UV laser beam over an amplitude mask or by a point-by-point exposure of the fiber to a focused beam. Although, by using special care, high-quality gratings can be manufactured this way, this method of grating writing is not practical for commercial purposes due to the high cost of the required UV lasers and their poor reliability.

Alternatively, long-period gratings can be made by periodically heating the fiber with an infrared laser beam, usually with a carbon dioxide (CO₂) laser. The advantage of the infrared grating writing is the low cost and the long lifetime of CO₂ lasers.

The physical mechanism of the grating formation by infrared light is fundamentally different compared to that of the UV writing. The UV radiation is absorbed only in the fiber core, where it interacts with defects of the glass structure and changes the connections between various atoms. In contrast, infrared light is fully absorbed by the fiber cladding, even before it reaches the core. This heats the fiber to very high temperature, when the glass almost melts. The softening of the glass results in a change of stresses induced in the fiber during its manufacturing, which in turn is translated into a perturbation of the refractive index through the photoelastic effect.

A typical grating writing configuration is shown in FIG. 1a. A fiber 100 is exposed to a beam of light 108 produced by a CO₂ laser 106. Beam 108 can be modulated with shutter 109 to produce a periodic exposure pattern on the fiber. Infrared beam 108 is usually focused on the fiber with a spherical lens 110. A more detailed view of the exposed fiber is shown in FIG. 1b. Due to the high absorption of the CO₂ laser radiation in glass cladding 104, the area 112 where the heating induced a change in the refractive index, is shifted towards the front of the fiber. The index change region 112 may or may not cover the core region 102, depending on the fiber used and the exposure conditions. In any case, due to the lack of axial symmetry of the index change, the spectra of such gratings show a multitude of random features, as was noted in the prior art (Davis et al., “Long-period Fibre Grating Fabrication with Focused CO₂ Laser Pulses,” Electronics Letters, v. 34, No. 3, p. 302-303, 1998). This makes it hard to use such gratings in any application where the spectral attenuation of gratings has to be precisely controlled, for example for gain-flattening of optical amplifiers.

Chung and Paek disclose a system for making axially-symmetric gratings with a CO₂ laser (Chung and Paek, “Fabrication and Performance Characteristics of Optical Fiber Gratings for Sensing Applications,” Proceedings of IEEE, v. 1, p. 36-42, 2002), shown in FIG. 2. The CO₂ laser beam 108 is expanded by a pair of lenses 200 and 202 and passed through a ring aperture 204, which essentially cuts out the center part of the beam. The ring-shaped beam is then reflected from a flat mirror 206 and is focused on the fiber 100 with a concave mirror 208 at location 210. The fiber 100 passes through apertures made in mirrors 206 and 208 and is supported by guides 212a and 212b. The translation of the fiber is performed by stage 214. While focusing the beam along the fiber achieves the required exposure symmetry, it also causes the location of the refractive index change to be poorly defined in the longitudinal direction. This is due to the general property of optical beams to be focused in a form of a “waist” of a certain length, rather than a point. Any aberrations of the concave mirror 208 or imperfections of the beam will further blur the focal area along the fiber. This means that only gratings with large periods (above 400-500 microns) can be made this way, which restricts this method to using only low numerical aperture fibers.

Such system also relies on precise optical alignment of multiple components, which is hard to maintain reliably in a production environment. Since fiber 100 has to overlap precisely with the axis of the beam focused by mirror 208, any deviation of the fiber off the axis will result in the reduction of writing efficiency and the loss of the axial symmetry of the exposure. In particular, due to the typical variations in the fiber's polymer coating thickness from one batch to another (which could be 10-20 microns), the fiber would have to be precisely aligned with the axis before each new grating is written. This will increase the manufacturing time and reduce the repeatability. Moreover, the fiber 100 has to be threaded through the holes in the mirrors 206 and 208, further adding to the manufacturing inconvenience. Finally, a significant portion of the CO₂ laser beam 108 is wasted by using the ring aperture 204, which removes the brightest central portion of the beam. In addition, this method is incapable of producing multiple gratings in parallel, which would be a great benefit in mass production.

Thus, it appears that none of the solutions for making long-period fiber gratings is well suited for commercial use. Hence, those skilled in the art have recognized a need for a method of, and apparatus for, writing long-period gratings using an infrared laser, which achieves axially-symmetric fiber exposure, so that the resulting gratings will couple light only to symmetric cladding modes and therefore will have clean spectra with easily controllable peaks and low polarization dependence. The need for a method of, and apparatus for, writing long-period gratings, which are inexpensive and easy to implement; have a minimum sensitivity to the fiber displacement, so that the need for fiber alignment before writing each grating is eliminated; minimize the waste of the infrared laser beam energy; and allow manufacturing of multiple identical gratings in parallel, has also been recognized. The invention fulfills these needs and others.

### SUMMARY OF THE INVENTION

Briefly, and in general terms, the invention is directed to methods of and apparatuses for producing optical fiber gratings. In one aspect, the invention relates to a method of producing a change in the refractive index of an optical fiber. The method includes directing a plurality of optical writing beams toward the optical fiber such that the axes of the plurality of beams are spaced substantially evenly around the circumference of the optical fiber and are directed substantially perpendicular to the axis of the optical fiber. The method also includes exposing the optical fiber to the plurality of optical writing beams for a time sufficient to heat the fiber to a temperature sufficient to produce a change in the refractive index of the optical fiber.

In another aspect, the invention relates to a method of manufacturing identical long-period gratings in a plurality of optical fibers. This method includes mounting the plurality of optical fibers approximately parallel to each other and providing a single input beam. The method also includes disposing a reflective element in the vicinity of the plurality of optical fibers that is capable of both generating a plurality of optical writing beams from the single input beam and directing the plurality of optical writing beams toward the optical fibers. The method further includes exposing the optical fiber to the plurality of optical writing beams for a time sufficient to heat the fiber to a temperature sufficient to produce a change in the refractive index of the optical fiber along a portion of the optical fiber.

In another aspect, the invention relates to an apparatus for manufacturing a long-period grating in an optical fiber. The apparatus includes a light source that provides an input beam with power sufficient to heat the optical fiber to produce a permanent change in the refractive index of the optical fiber. The apparatus also includes means for directing the input beam as a plurality of distinct optical writing beams toward the optical fiber such that the axes of the plurality of beams is spaced substantially evenly around the circumference of the optical fiber and is directed substantially perpendicular to the axis of the optical fiber. The apparatus further includes means for exposing the optical fiber to the plurality of optical writing beams for a time sufficient to heat the fiber to a temperature sufficient to produce a change in the refractive index of the optical fiber along a portion of the optical fiber.

In yet another aspect, the invention relates to a long-period fiber grating that is manufactured by a process that includes directing a plurality of optical writing beams toward an optical fiber such that the axes of the plurality of beams is spaced substantially evenly around the circumference of the optical fiber and is directed substantially perpendicular to the axis of the optical fiber. The process also includes exposing the optical fiber to the plurality of optical writing beams for a time sufficient to heat the fiber to a temperature sufficient to produce a change in the refractive index of the optical fiber; and varying the exposure of the plurality of optical writing beams along a portion of the optical fiber in a predetermined fashion to form a long-period grating.

These and other aspects and advantages of the invention will become apparent from the following detailed description and the accompanying drawings, which illustrate by way of example the features of the invention.

### BRIEF DESCRIPTION OF THE DRAWINGS

FIG. 1a illustrates the conventional method of writing long-period gratings with a CO₂ laser.

FIG. 1b schematically shows the spatial distribution of the refractive index change induced in the fiber by the conventional CO₂ laser writing method.

FIG. 2 shows a prior art solution for making axially-symmetric long-period gratings.

FIG. 3 depicts a general multi-beam writing method, and the axially-symmetric refractive index change distribution produced by such a method.

FIG. 4 illustrates a system where multiple beams are produced by splitting the main beam with beamsplitters and focused on the fiber individually.

FIG. 5 shows an arrangement for writing gratings with three symmetric beams produced from the original laser beam using a reflective element.

FIG. 6 shows an arrangement for writing gratings with four symmetric beams produced from the original laser beam using a reflective element.

FIG. 7a shows the transmission spectrum of a long period grating written in the conventional way, according to FIG. 1a.

FIG. 7b shows the transmission spectrum of a long period grating written using a 120° reflector, according to FIG. 4.

FIG. 8 depicts an arrangement for writing multiple gratings in parallel.

### DETAILED DESCRIPTION OF THE PREFERRED EMBODIMENTS

According to the present invention, a method of manufacturing axially-symmetric long-period gratings comprises an arrangement, which allows multiple infrared beams to converge on the exposed area of a fiber, in a direction perpendicular or nearly perpendicular to the fiber axis. The absorption of the beams in the fiber cladding uniformly heats the fiber, which translates into an axially-symmetric pattern of the refractive index perturbation. As a result, the long-period gratings produced with this method possess clean transmission spectra, with only a few predictable and polarization-independent loss peaks present. Such high-quality gratings and the method of their manufacturing are useful for production of wavelength-selective filters, for example for flattening the gain spectrum of a fiber amplifier.

At least two opposing writing beams are required, although three or more beams symmetrically striking the fiber will produce much more uniform exposure. Preferably, the writing beams irradiate the fiber simultaneously to provide the best axial symmetry of the heating. Alternatively, the writing beams can be turned on one at a time.

In one configuration of an apparatus for manufacturing optical grating, the infrared beam produced by a laser or another source of radiation is split into multiple beams by a series of beamsplitters or diffractive elements. The beams are then directed onto the fiber at appropriate angles with respect to each other but preferably perpendicular or nearly perpendicular to the fiber axis. In order to produce a sufficiently bright and defined spot on the fiber, the beams can be focused by a single focusing component (such as a convex lens or a concave mirror) placed before the beamsplitters, or by separate focusing components placed used with each individual beam.

In another configuration, the multiple beams are produced by a special reflector placed behind the fiber. For example, in a 3-beam system, this can be easily achieved by using a reflector comprised of two mirrors arranged at 120° with respect to each other. Alternatively, a single curved mirror could be used for the same purpose. The fiber alignment requirements can be tremendously reduced by focusing the laser beam with a cylindrical lens, which produces a narrow field of light perpendicular to the fiber. Multiple long-period gratings can be produced in parallel by placing the fibers next to each other, in front of the reflector.

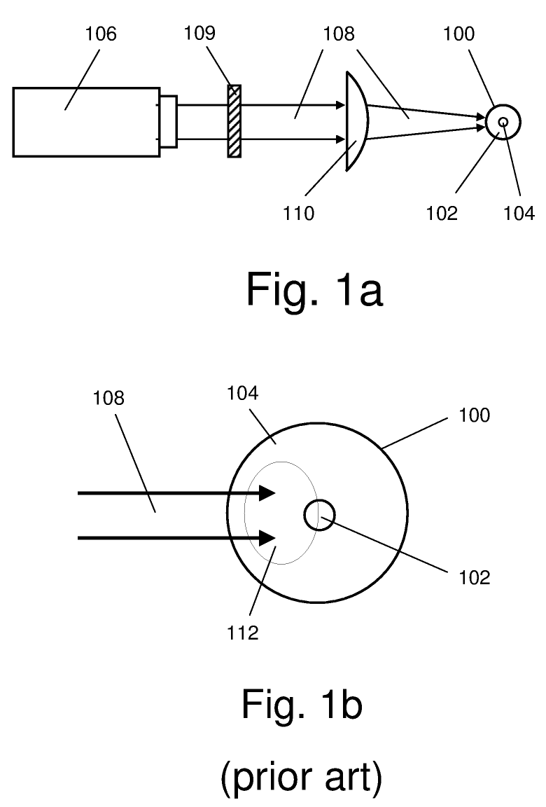

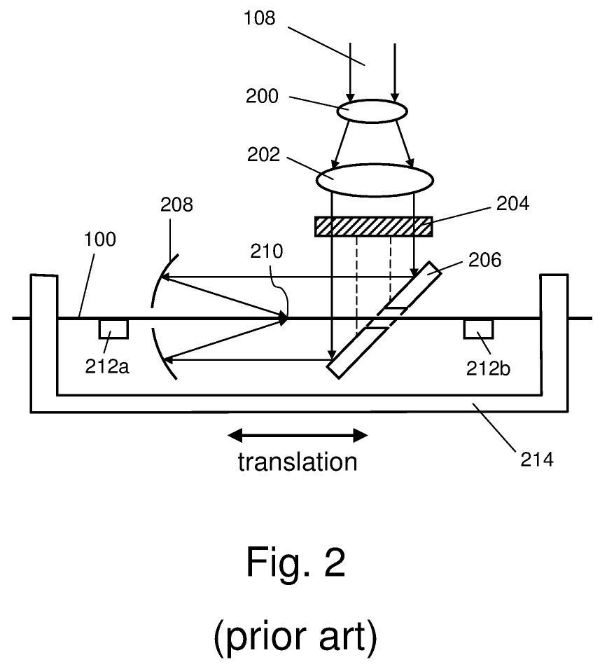

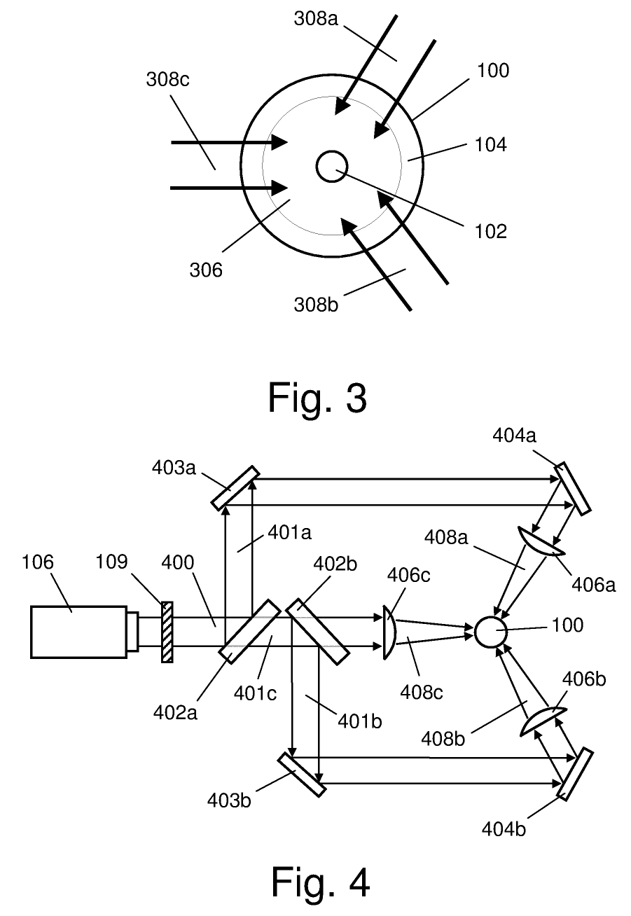

Referring now to the drawings, wherein the reference numerals denote like or corresponding parts throughout the figures, and particularly to FIG. 3, there is shown the general principle of writing long-period gratings with multiple light beams. Fiber 100 with core 102 and cladding 104 is arranged in such a way that multiple writing beams 308a, 308b, and 308c converge on the same location of the fiber. Preferably, beams 308a-308c strike fiber 100 at or near 90° angle to its axis, so that their overlap is more localized. Each of the writing beams is strongly absorbed and therefore deposits its energy in an area shifted from core 102 towards the beam direction, similar to heated area 112 in FIG. 1b. However, due to the presence of multiple beams striking the fiber in opposing directions, the heating of fiber 100 is more axially-symmetric than in FIG. 1b. The result is a nearly axially-symmetric area of the refractive index perturbation 306.

The wavelength of light is chosen such that the absorption of light in the fiber material is high enough to cause efficient heating of the fiber with the available light power, so that a permanent perturbation of the refractive index can be achieved as a result of such heating, due to either a change in glass structure or stress, or both. To achieve such a change, the glass has to be heated close to its softening point (the temperature at which the glass becomes soft). For example, for a common glass fiber predominantly made of silica, the required temperature is 1000-1500° C. Heating to this temperature could be easily accomplished by a few Watts of focused infrared light with wavelength 2.5-11 microns, since the absorption of silica in this wavelength range is very strong. In the subsequent discussion, the term “infrared beam” will be sometimes used to describe the heating source. However, it is evident that depending on the particular absorbing materials incorporated in the fiber cladding or core, the optimum wavelength may or may not be infrared.

The magnitude and the spatial distribution of the refractive index change produced by the light-induced heating will depend on the chemical composition of the fiber and the thermal properties of its core and cladding. In standard telecom fibers, which have a pure silica cladding and a core slightly doped with germanium, the softening points of both the core and the cladding are very close. This means that heating that softens the cladding will most likely affect the core as well. Therefore, the refractive indices of both the core and the cladding will be changed by such heating. In contrast, in a fiber whose core is doped with boron, the core will soften at much lower temperature than the cladding, so it will be possible under certain conditions to obtain refractive index changes localized only in the core. In any case, the multi-beam writing method provided by the present invention will be effective in producing gratings with axially-symmetric refractive index change distribution.

Because the heat-induced change in the refractive index happens only after a certain threshold temperature is reached, the fiber response is a highly nonlinear function of temperature. Therefore, it is advantageous to heat the fiber with all writing beams at the same time for better axial symmetry of refractive index perturbation 306. If the writing beams are turned on one at a time, a larger number of beams may be required to achieve good axial symmetry of the refractive index perturbation.

Although three writing beams are shown in FIG. 3, the present invention is by no means limited to such a number of beams. At least two writing beams are required for implementing this method, but three or more beams will produce much more uniform heating of the fiber. In practice, a three-beam system is usually the best compromise between the exposure quality and the writing arrangement complexity, this is why it is shown in most of the drawings. For making the most uniform exposure possible, it is desirable to have the beams converge on the fiber in a symmetric fashion, with identical angles between the adjacent beams. This means the best angle between the beams when using N beams is 360°/N. In other words, if only 2 beams are used, we need to arrange them at 180° with respect to each other, 3 beams—120°, 4 beams—90°, etc. Preferably, the writing beams are same or close in power, so that the heating of the fiber is the same in every direction.

Typical long-period gratings are structures with periods 100-500 microns. In contrast, the diameter of a typical writing laser beam is 1-5 mm, which is 10 times larger. The required spatial resolution for writing the gratings can be achieved by passing the beam through an amplitude mask. Recording the grating is then accomplished by simply scanning the writing beam over the mask while irradiating the fiber behind the mask. Alternatively, the required spatial resolution can be achieved by focusing the writing beam and varying the exposure while translating the fiber along its axis, either by changing the intensity of the beam or by changing the speed of the fiber translation.

Focusing the beams can be accomplished by using lenses or curved mirrors. FIG. 4 shows one possible arrangement of the apparatus for manufacturing gratings. Laser beam 400 produced by laser 106 is split into writing beams 401a, 401b, and 401c with beamsplitters 402a and 402b. Beam 400 can be modulated with shutter 109 to produce a periodic exposure pattern on the fiber 100. Two of the writing beams 401a, 401b are initially directed away from the fiber 100 while one of the writing beams 401c continues toward the front side of the fiber. The two beams 401a, 401b directed away from the fiber 100 are eventually redirected toward the backside portion of the fiber by mirrors 403a, 403b, 404a, and 404b along a path substantially perpendicular to the axis of the fiber. This path is spaced a sufficient distance from the fiber 100 so as to avoids any incidental interference between the writing beams 401a, 401b and the fiber prior to final reflection of the writing beams from their respective mirrors 404a, 404b. All three writing beams are focused on the fiber by spherical lenses 406a, 406b, and 406c. The focused beams 408a, 408b, and 408c then converge on the fiber in a single spot. In this arrangement, the efficiency of the laser power usage will be maximized, since nearly all available light can be focused on the fiber. Lenses 406a and 406b could be eliminated if mirrors 404a and 404b are concave mirrors, which focus the writing beams on the fiber directly. Lenses 406a, 406b, and 406c could also be cylindrical lenses focusing light into lines (rather than spots) perpendicular to the axis of fiber 100. While the power efficiency of such an arrangement is lower, the requirements for the fiber alignment precision will be eased due to achieving a larger, more uniform spot on the fiber.

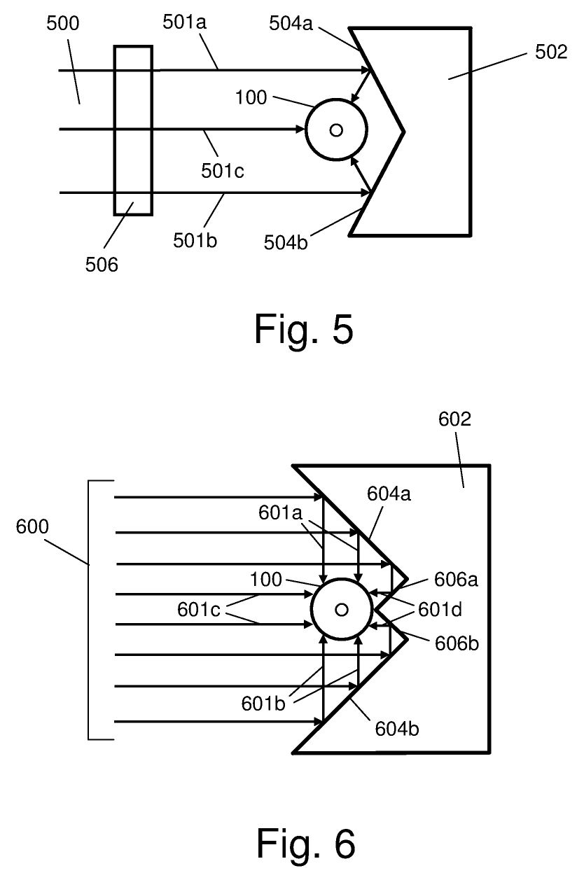

To further simplify the grating writing arrangement, the beam splitting, steering, and alignment can be performed by a single reflective element 502, as shown in FIG. 5. In order to create two additional writing beams from a single laser beam 500, reflective element is made of two reflective surfaces 504a and 504b, preferably joined together as a single element for easy alignment. The center portion of the beam 501c directly strikes fiber 100. The edge portions of the beam 501a and 501b first travel along a path away from and past the fiber 100, then are reflected from surfaces 504a and 504b, and finally strike the fiber from the back. In order for all three writing beams to converge on fiber 100 at the same angles (120°), the angle between reflective surfaces 504a and 504b should be equal to 120°, and the angles between each surface and beam 500 should be equal to 60°. In order to provide uniform exposure along the fiber, the reflective surfaces should be parallel to the fiber.

In order to achieve the best symmetry of fiber heating, it would be advantageous for the writing beams 501a, 501b, and 501c to have identical power. It is clear that if the width of beam 500 is close to fiber 100 diameter (125 microns for typical fibers), the edges of the beam 501a and 501b will have much lower power than the beam center 501c. Therefore, it would be desirable to make writing beam 500 wide, with the width at least 3 times larger than the fiber diameter (>375 microns). On the other hand, beam 500 should be no wider than the half of the grating period, which is ˜50-250 microns, in the direction along the fiber, in order to provide sufficient spatial resolution of fabricating the grating. Therefore, beam 500 has to be much more narrow in the direction along fiber 100 than across it when it strikes the fiber. This could be achieved by using a cylindrical lens 506, which focuses beam 500 into a line perpendicular to the fiber axis. Such focusing will also result in nearly uniform light intensity around fiber 100, so any small misalignment of the fiber will not cause a significant drop of the fiber temperature during the exposure.

Instead of using a “V-groove” reflective element with two flat reflective surfaces 502, one could also use a concave mirror for the same purpose. In this case, distance between the fiber and the mirror would have to be close to twice the focal length of the mirror to collect the light efficiently.

The method of writing axially-symmetric long-period gratings using a reflective element positioned behind the fiber can be easily extended to using more than three writing beams. To do this, the shape of the reflective element would be modified. For example, FIG. 6 illustrates this method for using four writing beams. Laser beam 600 is split into writing beams 601a-601d by reflective element 602 having primary reflective surfaces 604a and 604b and secondary reflective surfaces 606a and 606b. Primary surfaces 604a and 604b are perpendicular to each other, and are tilted at 45° with respect to laser beam 600. Therefore, beams 601a and 601b strike fiber 100 vertically upon reflecting from surfaces 604a and 604b, respectively. Secondary reflective surfaces 606a and 606b are perpendicular to primary surfaces 604a and 604b, respectively. Since beam 601d is reflected first from primary surfaces 604a and 604b and then from secondary surfaces 606a and 606b, it effectively turns by 180° becoming opposite to center writing beam 601c. Thus, the four writing beams 601a-601d strike fiber 100 at 90° to each other providing uniform heating of the fiber. Note that this configuration can also serve for a two-beam exposure. This will happen if beam 600 is narrow enough, so that edge portions of it 601a and 601b are absent. In this case, the grating will be formed only by opposing beams 601c and 601d.

It is clear that special care should be taken when choosing the material for making reflective elements such as 502 and 602. Because the reflective surfaces will experience nearly focused high-power laser beams, any absorption of light in these reflectors may cause excessive heating and degradation over time. Therefore, the reflective surfaces must have nearly 100% reflectivity and the bulk material of the reflective elements should have good thermal conductivity to dissipate the heat efficiently. In addition, chemical inertness of the surface would be desirable because the reflective elements could be exposed to high-temperature environment generated near the fiber surface by the infrared beam. For these reasons, solid gold with polished reflective surfaces is an excellent choice for making such reflectors. However, other metals or dielectric coatings may be used as well.

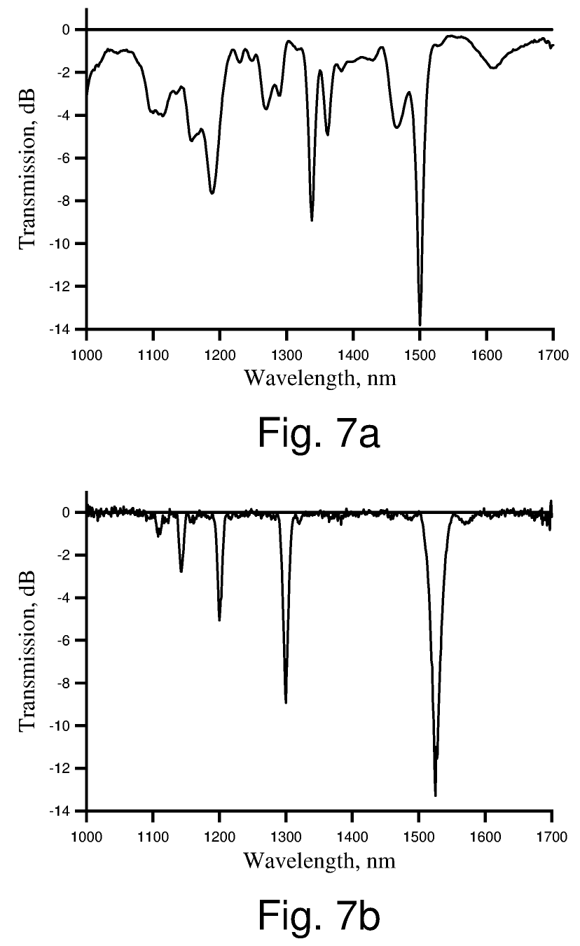

FIGS. 7a and 7b illustrate the effectiveness of the reflective elements for making axially-symmetric long-period gratings. Each of the gratings was written in Corning SMF-28 fiber using a 25-W CO₂ laser operating at 10.6 micron wavelength. The beam was focused on the fiber with a cylindrical lens, thus creating a narrow line perpendicular to the fiber. FIG. 7a shows the result of writing a grating in the conventional way, using a single beam (similar to FIG. 1a). Due to the asymmetry of the induced index change profile, the light from the fiber core is coupled to a large number of asymmetric cladding modes resulting in a somewhat chaotic and unpredictable transmission spectrum. FIG. 7b shows the spectrum of a similar grating written with a three-beam method, similar to that shown in FIG. 5. The laser power was reduced here by a factor of three in order to account for three beams hitting the fiber instead of one. In contrast to FIG. 7a, only five narrow and symmetric notches are present in the whole spectrum. They correspond to light coupling only into symmetric cladding modes. Such narrow, isolated notches are useful for making wavelength-selective filters because they allow attenuation of one wavelength without affecting the others.

Note that the loss of the grating in FIG. 7b for the wavelengths away from the resonances is less than 0.2 dB. The polarization dependence of such gratings is also very low. Typically, a 10-db notch will have a polarization-dependent loss of less than 0.1 dB. In addition, the positions and shape of the notches can be easily simulated by a computer (given the fiber parameters), which allows to fabricate filters of complex shapes using a combination of specially designed gratings.

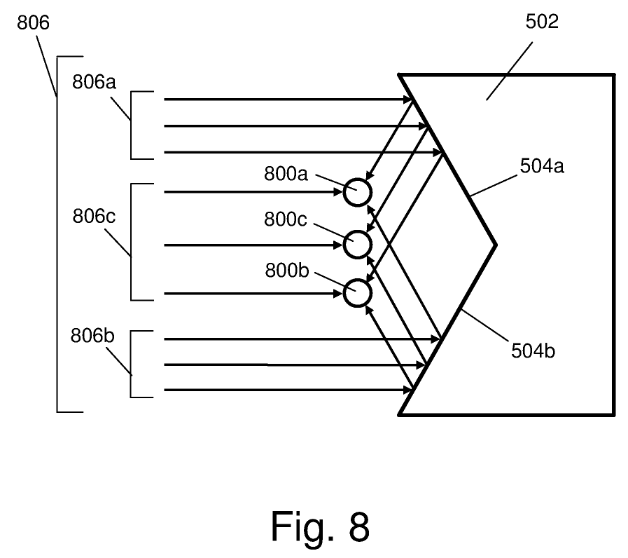

For mass production of gratings, it would be extremely valuable to be able to write a few identical gratings in parallel. FIG. 8 illustrates how this can be done using the three-beam writing arrangement with a 120° reflector from FIG. 5. Fibers 800-a-800c are placed in a line substantially perpendicular to the beam 806. If the beam 806 is wide enough, which can be readily achieved by focusing it with a cylindrical lens, the edge portions of the beam 806a, 806b will provide effective irradiation of the back sides of the fibers, while the center beam 806c will irradiate the front side. The fibers 100 should be separated from each other to prevent shading. If a 120° reflective element is used (as shown in FIG. 8), the optimum separation between the fibers is approximately equal to the fiber diameter, which is typically about 125 microns.

In conclusion, the present invention provides a method of manufacturing long-period fiber gratings with multiple infrared laser beams, in order to achieve axially-symmetric heating of the fiber. The resulting gratings have very low insertion loss and are free from unwanted resonances. This method has low sensitivity to fiber misalignment and allows for writing multiple gratings in parallel.

It will be apparent from the foregoing that while particular forms of the invention have been illustrated and described, various modifications can be made without departing from the spirit and scope of the invention. Accordingly, it is not intended that the invention be limited, except as by the appended claims.

1. A method of producing an axially-symmetric change in the refractive index of an optical fiber comprising:
directing a plurality of optical writing beams toward the optical fiber, the axes of the plurality of beams spaced substantially evenly around the circumference of the optical fiber and directed substantially perpendicular to the axis of the optical fiber; and
exposing the optical fiber to the plurality of optical writing beams for a time sufficient to heat the fiber to a temperature sufficient to produce a change in the refractive index of the optical fiber.

2. The method of claim 1 wherein the plurality of optical writing beams strike the optical fiber approximately simultaneously.

3. The method of claim 1 wherein the plurality of optical writing beams strike the optical fiber one at a time.

4. The method of claim 1 wherein the plurality of optical writing beams have approximately the same power.

5. The method of claim 1 wherein directing a plurality of optical writing beams comprises:
outputting a source optical writing beam from a single beam source;
initially directing at least one portion of the source optical writing beam away from the optical fiber; and
redirecting at least one portion of the source optical writing beam toward the optical fiber as one of the plurality of optical writing beams.

6. The method of claim 1 wherein the plurality of optical writing beams is produced by an infrared laser.

7. The method of claim 1 wherein the plurality of optical writing beams is produced by a carbon dioxide laser.

8. The method of claim 1 further comprising varying the exposure of the plurality of optical writing beams along a portion of the optical fiber in a predetermined fashion to form a long-period grating.

9. The method of claim 8 wherein varying the exposure comprises:
focusing the plurality of optical writing beams onto the optical fiber to form a spot substantially smaller than the period of the grating; and
translating the optical fiber along its axis.

10. The method of claim 9 further comprising varying the power of the plurality of optical writing beams.

11. A method of manufacturing a long-period grating by producing an axially-symmetric refractive index change in an optical fiber; said method comprising:
mounting the optical fiber;
providing a single input beam;
focusing the input beam onto the fiber using a cylindrical lens, the focused beam shaped as a line approximately perpendicular to the fiber;
disposing a reflective element in the vicinity of the optical fiber, the reflective element capable of generating a plurality of optical writing beams from the single input beam and directing the plurality of optical writing beams toward the optical fiber;
exposing the optical fiber to the plurality of optical writing beams for a time sufficient to heat the fiber to a temperature sufficient to produce a change in the refractive index of the optical fiber along a portion of the optical fiber; and
varying the exposure to the plurality of optical writing beams along the portion of the optical fiber in a predetermined fashion to form the long-period grating.

12. The method of claim 11 further comprising mounting at least one additional optical fiber to form a plurality of optical fibers for simultaneous manufacturing of identical long-period gratings using said single input beam; said plurality of optical fibers mounted to receive approximately equal exposure to the plurality of optical writing beams.

13. The method of claim 12 wherein the plurality of optical fibers are mounted in a plane approximately perpendicular to the direction of the input beam.

14. An apparatus for manufacturing a long-period grating by
producing an axially-symmetric refractive index change in an optical fiber, said apparatus comprising:
a light source providing an input beam with power sufficient to heat the optical fiber to produce a permanent change in the refractive index of the optical fiber;
means for directing the input beam as a plurality of distinct optical writing beams toward the optical fiber, the axes of the plurality of beams spaced substantially evenly around the circumference of the optical fiber and directed substantially perpendicular to the axis of the optical fiber;
means for exposing the optical fiber to the plurality of optical writing beams for a time sufficient to heat the fiber to a temperature sufficient to produce a change in the refractive index of the optical fiber along a portion of the optical fiber; and
means for varying the exposure to the plurality of optical writing beams along the portion of the optical fiber in a predetermined fashion to form a long-period grating.

15. The apparatus of claim 14 wherein the means for directing comprises a beam splitter configured to receive the input beam as an input and to output the plurality of optical writing beams.

16. The apparatus of claim 14 wherein the means for directing comprises at least one reflective element configured to be disposed in the vicinity of the optical fiber.

17. The apparatus of claim 16 wherein the means for directing comprises a cylindrical lens focusing the input beam onto the fiber as a line approximately perpendicular to the fiber and the reflective element comprises two flat reflective surfaces configured to be approximately parallel to the optical fiber, with about a 120 degree angle between the reflective surfaces and about a 60 degree angle between each of the reflective surfaces and the input beam.

18. The apparatus of claim 14 wherein the means for varying the exposure comprises:
at least one device for focusing the plurality of optical writing beams onto the optical fiber to form a spot substantially smaller than the period of the grating;
and means for translating the optical fiber along its axis.

19. The apparatus of claim 18 wherein the means for varying the exposure comprises further comprises means for varying the power of the plurality of optical writing beams.

20. An axially-symmetric long-period fiber grating manufactured by a process comprising:
directing a plurality of optical writing beams toward an optical fiber, the axes of the plurality of beams spaced substantially evenly around the circumference of the optical fiber and directed substantially perpendicular to the axis of the optical fiber;
exposing the optical fiber to the plurality of optical writing beams for a time sufficient to heat the fiber to a temperature sufficient to produce a change in the refractive index of the optical fiber;
and varying the exposure of the plurality of optical writing beams along a portion of the optical fiber in a predetermined fashion to form a long-period grating.
